(19) United States
(12) Patent Application Publication
(10) Pub. No.: US 2004/0228443 A1
(43) Pub. Date: Nov. 18, 2004

(54) Method and apparatus to determine and document applied x-ray exposure values

(76) Inventors: Stefan Bohm, Oberasbach (DE); Bernhard Geiger, Buckenhof (DE); Helmuth Schramm, Neunkirchen (DE); Martin Spahn, Erlangen (DE)

Correspondence Address: SCHIFF HARDIN, LLP, PATENT DEPARTMENT, 6600 SEARS TOWER, CHICAGO, IL, 60606-6473, US

(21) Appl. No.: 10/799,494

(22) Filed: Mar. 12, 2004

(30) Foreign Application Priority Data
Mar. 14, 2003 (DE) 103 11 627.3

(51) Int. Cl. G01N 23/04; H05G 1/42

(52) U.S. Cl. 378/97

(57) ABSTRACT

In a method and apparatus for determining and documenting, from current x-ray image data, x-ray exposure values employed for producing an x-ray exposure or a sequence of x-ray exposures by irradiation of a radiation detector with x-rays form an x-ray diagnostic source, an exposed image region of the radiation detector is determined, and a region of interest within the exposed image region also is determined. An x-ray image exposure value is determined from the grey scale values of the pixels in the region of interest. The x-ray image exposure value is normalized with respect to a signal value. Measurement values employed for producing the exposed image region are independently measured, and, using these measurement values, the normalized value is converted into a physical unit. The physical unit is stored, associated with the measurement values, for documentation.

### BACKGROUND OF THE INVENTION

1. Field of the Invention

The present invention concerns a method as well as an apparatus to determine and document the x-ray exposure values employed by an x-ray diagnostic device for an x-ray exposure or x-ray acquisition sequence.

2. Description of the Prior Art

An essential factor in the development of x-ray systems for angiography, fluoroscopy, cardiology and skeleton radiography in recent years has been the improvement of the workflow, meaning optimization of the work progression before, during and after the examination. Improvements have been achieved, for example, by the involvement of RIS/HIS systems and PACS systems. The automatic positioning of the systems based on the selected organ computer program is a further example for the improvement of the workflow.

FIG. 1 shows an x-ray display device known from German Patent 195 27 148, with a first stand 1 to which an x-ray radiator 2 is mounted so as to be adjustable in height. The x-ray radiator 2 generates a conical x-ray beam 3 that is gated by a diaphragm and that penetrates a subject 5 (for example a patient). An x-ray detector 7 is attached to a second stand 6 such that it is aligned to the x-ray radiator 2 with regard to height, so that the x-rays in the beam 3 attenuated by the subject 5 strike on the x-ray detector 5. A scattered-ray grid 8 is arranged in front of the x-ray detector 7.

A system control unit 9 generates the necessarily clock and control signals for the x-ray diagnostic device, that are supplied to the other components of the x-ray diagnostic device via control and data lines 10, A high-voltage generator 11 supplies the x-ray tube of the x-ray radiator 2 with high-voltage and filament-voltage.

The output signal of the x-ray detector 7 is supplied to an image computer or image system 12 that can include computers, transducers, image memories and processing circuits. The image system 12 is connected with a supervision monitor 13 for reproduction of the acquired x-ray images.

### SUMMARY OF THE INVENTION

In the case of digital image receivers, it is desirable to document a measurement for the x-ray exposure obtained in a specific exposure or acquisition sequence. This serves to allow comparison of the exposure values of a current exposure or sequence with the typical exposure values for the respective organ, as well as to provide a testing means that ensures the stability of the measurement system.

An object of the present invention is to provide a method and an apparatus of the initially cited type, which allow x-ray exposure values employed by an x-ray diagnostic device for an x-ray exposure or x-ray acquisition sequence to be determined and documented from current image data.

The above object is achieved in accordance with the principles of the present invention in a method wherein a determination of the exposed image region of an x-ray detector in an x-ray diagnostic apparatus is made, and from this determination a region of interest is determined. An x-ray exposure value is determined for the region of interest representing the grey scale values of the pixels in the region of interest. This x-ray image value is normalized to a signal value. Measurement values employed in x-ray diagnostic device for producing the x-ray exposure are independently determined. The measurement values are used to convert the normalized value to a physical unit. The value for the physical unit is stored, associated with the measurement values, for documentation,

By the determination of a fixed region as well as an ROI from the actual exposed region of the detector (that, due to gating of the x-ray beam can be smaller than the active surface of the detector), a value is obtained that can serve as an indicator of the x-ray exposure values that were used. This x-ray exposure value is associated with the x-ray dose. The calculation of this value ensues from the digital image.

An advantage of this method compared to conventional methods is that typically not only the employed exposure values such as tube voltage (kV) and current-time product (mAs) can be specified, but also a value can be directly extracted from the image that is directly associated with the corresponding exposure values for the some organ. This enables both stability measurements of the system over long periods of time and the immediate supervision of the current acquisition by comparison with known typical values for this organ. A supervision of the x-ray exposure values used is obtained by the use of the digital image information,

It has proven to be advantageous to determine the region of interest in the inventive method to divide the exposed image region is divided into a number (for example nine) of equally large partial areas, in the example of nine such partial regions, three divisions ensue in each dimension.

The middle partial area can be inventively selected as a region of interest.

An arbitrary contiguous or non-contiguous combination of ROI partial areas can be used for further calculation.

The grey scale values of the partial areas can be weighted differently.

For calculating a value representing the ROI in the inventive method an averaging of all pixel values is implemented. The arithmetic, geometric or harmonic mean value can be determined for this purpose. Alternatively, a median of all pixel values can be formed, or the lowest and the highest grey values can be cast out before the determination of the average value is formed from the remainder of the grey values of all pixel values (truncated mean).

The combination of the independently determined measurement values to convert the normalized values to a physical unit according to step f) can inventively ensue by means of a model of a physical unit (for example radiation dose). This can ensue, for example for an employed kV value and an assumed radiation hardness increase due to filtering and the effect of the patient, by determining the spectrum, based on the model that agrees with the detector and/or the system dose on the input surface (active area) of the detector.

This determination can be calculated by interpolation from a raster (grid) of measurements and the actual kV value, the detected signal strength and the estimated radiation hardness increase (filtering).

In accordance with the invention, the combination represents a mathematical association (expression) that produces the relationship between the normalized value and dose as a linear transformation from independently determined calibration data.

The method can be applied to the original data that have still undergone no organ-dependent or clinical image post-processing, or to further-processed image data that have undergone an organ-dependent or clinical image post-processing. In the latter case, the original, linear signal value is obtained by a calculation or mode that represents the inverse or converse of the processing that has taken place.

The above object also is achieved in accordance with the principles of the present invention in an x-ray diagnostic apparatus for implementing the above-described method, having an x-ray source and a radiation detector and an image system supplied with electrical signals from the detector, representing grey scale values for the pixels struck by x-rays from the source. The image system has an image determination unit that is supplied with the output signals from the radiation detector, that determines the aforementioned exposed image region, and which supplies a signal to an ROI determination unit, that determines the aforementioned region of interest. The output signal from the ROI determination unit is supplied to a first calculation unit that determines the aforementioned x-ray image exposure value from the grey scale values of the x-ray image in the region of interest in a normalization unit, this x-ray image exposure value is normalized with respect to a signal value. The apparatus includes at least one measurement unit that determines an independent measurement value employed by the apparatus for producing the x-ray image. A second calculation unit mathematically calculates a physical unit from the normalized value and the measurement value, A storage unit stores the physical unit associated with the measurement value.

The first calculation unit that determines a value representing the grey-levels of an x-ray image in the ROI, can be an average level formation unit.

The measurement device that determines independent measurement values can determine the employed kV, mAs and filter values.

The second calculation unit that combines the normalized values and the measurement values, can implement a combination of the normalized value on a physical unit by conversion based on model formation.

The second calculation unit can operate such that the implemented combination represents a linear transformation that produces the relationship between the normalized value and the dose radiation from independently determined calibration data.

### DESCRIPTION OF THE DRAWINGS

FIG. 1 is a schematic illustration of a known x-ray diagnostic device.

FIGS. 2 and 3 illustrate an example for determination of an ROI (region of interest) for a central portion of an image in accordance with the invention.

FIGS. 4 and 5 illustrate an example for the determination of an ROI with rotated gating of an image in accordance with the invention.

FIG. 6 illustrates an example for the determination of a cluster of ROIs (regions of interest) composed of 36 partial areas of an image in accordance with the invention.

FIG. 7 is a block diagram of an image system according to the invention that can replace the image system 12 in the known device of FIG. 1.

FIG. 8 is a flowchart of the inventive method steps.

### DESCRIPTION OF THE PREFERRED EMBODIMENTS

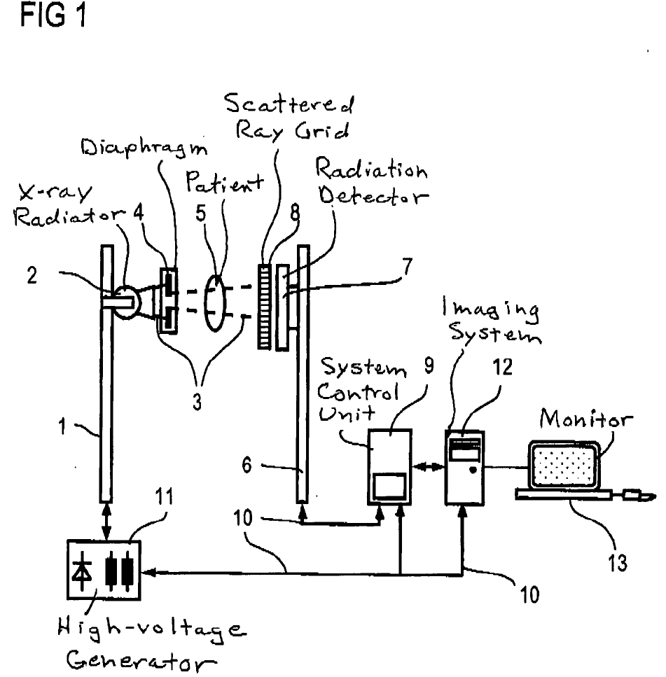

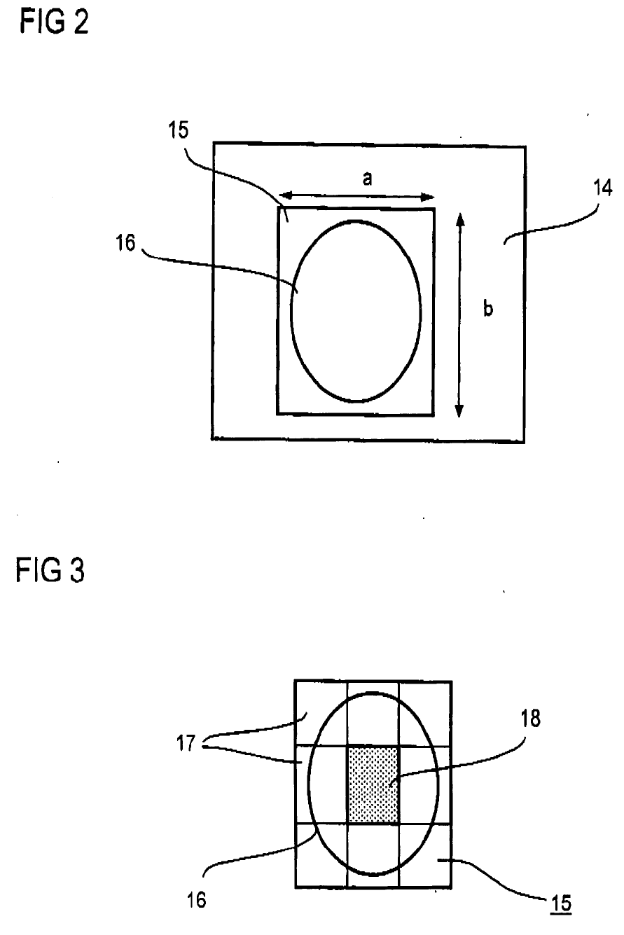

Using FIGS. 2 and 3, the inventive evaluation of the image region including the determination of regions of interest (ROIs) for a further calculation of the x-ray exposure values is explained in detail. The image can be produced using a device as shown in FIG. 1. The position and size of the projected tube-side image region 15 (defined by the diaphragm 4) that shows an exposure of only a part of the active surface 14 of the detector 7 is first determined. Automatic or manual methods known that are suited for this purpose.

Thus, for example, transmitters (not shown) can be provided on the diaphragm 4 that signal their position to an input 24 of the inventive image system 12a, which can replace the large system 12 in FIG. 1. The image system 12a from this input the exposed area of the x-ray detector 7. Alternatively, the image system 12a can include a device that, based on the output signals of the x-ray detector 7, determines the pixels that are struck by direct radiation (as described is, for example, in DE 197 42 152 A1).

The image of the examined subject 16 is indicated on a part of the exposed image region 15.

The image region 15 that is determined in such a way is divided into (in this example) nine respective equally large partial areas 17, by three divisions in each dimension (a×b=3×3). The partial areas 17 thus exhibit the dimensions of ⅓a*⅓b. The central region is used as the region of interest ROI 18 for further processing.

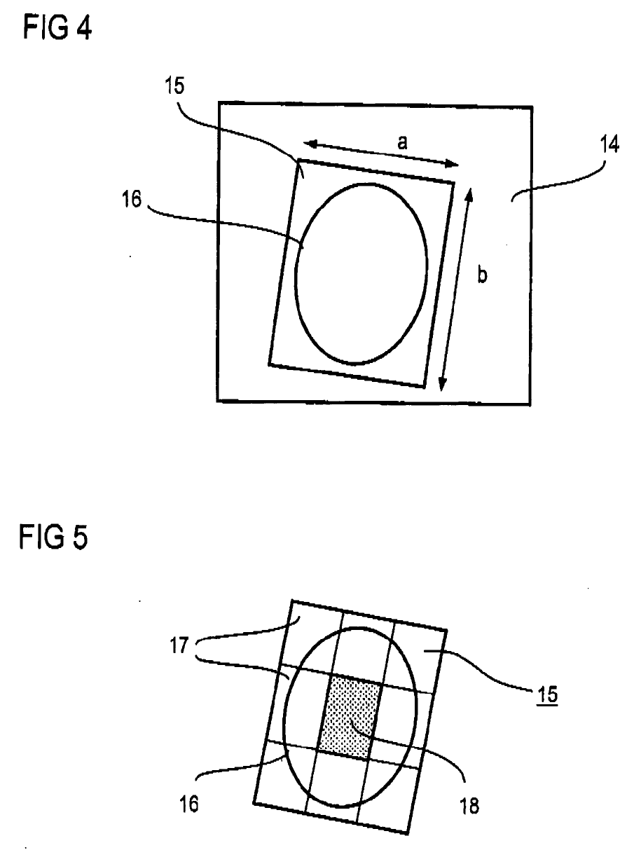

A further example to determine the ROI 18 is shown in FIGS. 4 and 5. Here, the central third is likewise used in both dimensions, given a rotated gating. Thus the same circumstance is shown, with the only difference being that a rotated position of the depth diaphragm 4 is employed.

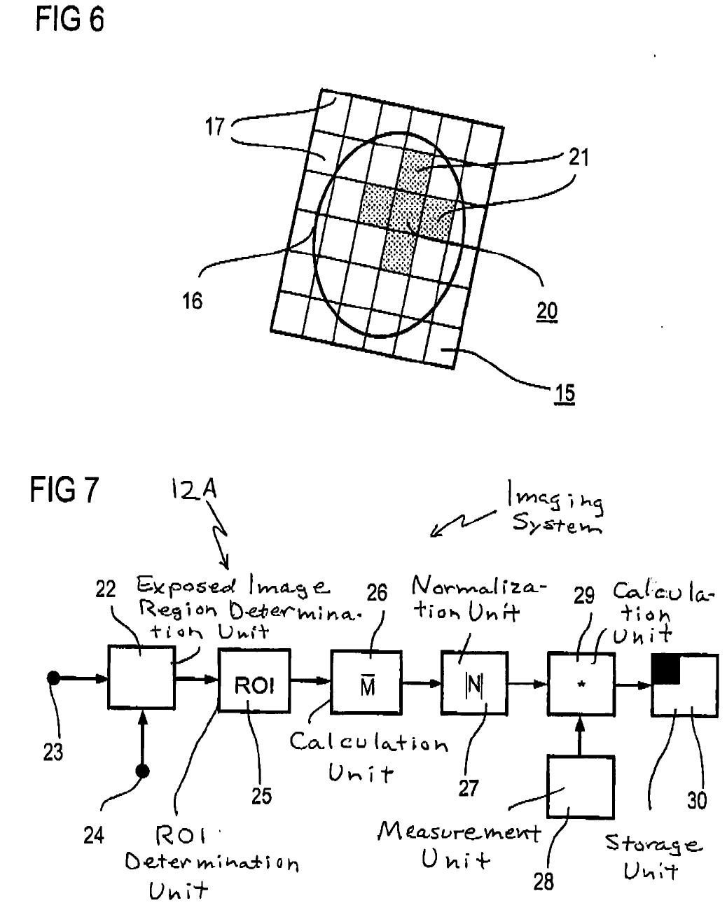

The same adjustment as in FIG. 5 is reproduced in FIG. 6. FIG. 6 shows a third example, wherein a cluster of ROIs (regions of interest) is determined for the further calculation of the x-ray exposure values. Only a finer division of the image region 15 has been effected. 6×6 partial areas 19 are formed in the shown example. Depending on the size and shape of the subject, however, for example 20×30 or 50×50 partial areas 19 could be provided.

From these partial areas 19, an ROI 20 is now selected that can be formed from an arbitrary combination of ROI partial areas 21, These ROI partial areas 21 combined into clusters can thereby be contiguous as shown, but, an arbitrary non-contiguous combination of ROI partial areas 21 also can be used for further calculation. This definition of smaller divisions that are combined again in the form of clusters, serves the purpose of circumscribing the part of the organ that is important for the measurement in a well-defined manner.

Instead of the shown rectangular partial areas 17 and 19, trapezoidal partial areas can be created with angular projections. For example, a division analogous to FIGS. 3, 5 and 6 can be achieved in the form of a division of each of the 4 edges into thirds, with the opposite points being connected with the middle area being used for the evaluation. A generalization to a number of smaller area units again can be implemented.

After this determination and selection of the ROIs, a further processing and calculation of an x-ray exposure value ensues. The means value formation (for example the formation of arithmetic average of the grey scale levels) of all pixels is the simplest method. The value calculated thus is the desired quantity that is displayed and is valid as a measurement for the x-ray exposure value.

The geometric or harmonic mean value alternatively can be determined. A median can be used instead of the mean value. Likewise, a so-called truncated mean can be used, in which the lowest grey scale values (for example 10%) and the highest grey scale values (likewise 10%) of all grey scale values are cast out (meaning eliminated) before determination of the mean value from the remaining 80% of the grey scale values.

By a normalization of such a determined mean grey scale value representing an ROI with respect to a maximum possible signal value, a relative representation of this mean value as a percentile value is obtained.

By combining this normalized value with independently determined measurement values, the measurement value can be converted into a physical unit, for example the radiation dose, using a model. The combination, for example, can be a mathematical expression that produces, from independently determined calibration data, the relationship between the normalized value and the dose (for example as a linear transformation) Thus the spectrum of x-rays that strike the x-ray detector 7 can be representative of the kV value that was used, taking into account an assumed radiation hardness increase that occurs due to filtering and the effects of the patient (this is achieved by means of a model). By means of otherwise-determined signal values that correspond to determined spectra and measured x-ray doses, the approximate system dose—the dose that strikes the input area (effective active area) of the x-ray detector 7—can be specified. The determination must be calculated by interpolation from a raster of measurements and the actual kV value, detected signal strength and the estimated radiation hardness increase (filtering).

Given a combination of a number of ROIs, the mean value formation can be implemented as any of the following:

Average value, median, etc. from all ROIs or ROI clusters, or

Different weighting of the average values, medians, “truncated means” from the various ROIs for processing of the final value

Example: desired value (x-ray exposure value)=50% of the average value of the ROI1+25% of the average value of the ROI2+25% of the average value of the ROI3

Two possibilities are available as digital image data that are used for analysis and drawn upon for the calculation:

Original image data that have not yet undergone organ-dependent or, respectively, clinical image post-processing. The image data are frequently linear to the detected signal. In each case, the image data are in direct relation to the applied dose.

Further-processed image data, which are images that have already been clinically further-processed, whereby the further processing can comprise, for example, nonlinear gradation curves, filterings and the like. In these cases, in order to arrive at the original linear signal value in the region of interest, the image processing is calculated inversely. This also enables the desired value to be retroactively [subsequently] extracted from the processed image.

An inventive image system 12a is shown in FIG. 7. The system 12a has a device 22 to determine the exposed image region, to which is supplied the output signal of the x-ray detector 7 at a first input 23. If the position of the diaphragm 4 is acquired by transmitters (not shown) attached to the plates of the diaphragm 4, the output signals of the transmitters can be supplied via a second input 24 to the device 22 to determine the exposed image region 15. Alternatively, as noted above, the device 22 can independently determine the exposed image region 15 based on the exposed part of the active surface 14 of the x-ray detector 7. The second input 24 is then omitted.

The output signal of the x-ray detector (that represents to the grey values of the image points or pixels of the image region 15) is then supplied to a device 25 to determine an ROI 18 or 20. The grey scale values of the image points within the ROI 18 or 20 are supplied to a first calculation unit 26 that determines a value representing the grey scale values of an x-ray image in the ROI 18 or 20, This can be on the mean formation described above. The output signal of the calculation unit 20 is supplied to a normalization unit 27 that compares the average value with a normalized value that, for example, corresponds to the maximum possible signal value. A relative representation of the value as a percentile quantity is thereby obtained.

Furthermore, the image system 12a has a measurement unit 28 that determines independent measurement values such as, for example, the employed kV, mAs and filter values. The output signals from the normalization unit 27 as well as from the measurement unit 28 are supplied to a second calculation unit 29 that implements a combination of the normalized values to a physical unit by conversion. This can ensue, as already specified, using a model. These combined values are stored associated with the individual images or image sequences, in a storage unit 30 for documentation.

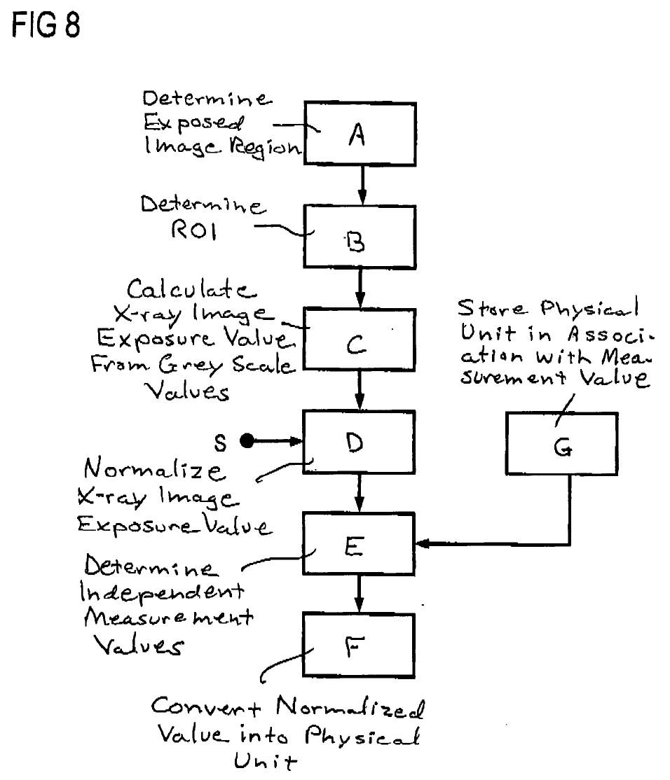

The progression of the inventive method is shown as a flowchart in FIG. 8. In a first step A), the exposed image region 15 is determined from the entire output signal of the active area 14 of the x-ray detector 7. As a further step B), the ROI 18 or 20 is determined within the image of the subject, as explained, for example using FIGS. 2 through 6. In a step C), the grey scale values for the x-ray image is subsequently calculated from the grey scale values representing the determined ROI 18 or 20. This ensues as described above, for example by averaging. In a subsequent step D, the x-ray image exposure value calculated according to step C) is normalized with respect to a maximum signal value S.

Parallel to this, independent measurement values of the x-ray diagnostic device are determined in a step E). These measurement values are combined with the normalized grey scale mean value from which a physical unit is determined. This value is stored in a step G) for documentation.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for determining and documenting, from current image date, x-ray exposure values employed for producing an x-ray exposure or an x-ray image acquisition sequence in an x-ray diagnostic apparatus, comprising the steps of:
electronically irradiating a radiation detector with x-rays to expose an exposed image region comprised of pixels each having a grey scale value;
electronically determining a region of interest within said exposed image region;
electronically calculating an x-ray image exposure value for the region of interest from the grey scale values of the pixels in the region of interest;
electronically normalizing the x-ray image exposure value to a signal value, to obtain a normalized value;
electronically determining at least one independent measurement value employed in the x-ray diagnostic apparatus for generating said exposed image region;
electronically mathematically converting said normalized value into a physical unit using said measurement value; and
electronically storing said physical unit in association with said measurement value for documentation.

2. A method as claimed in claim 1 comprising electronically determining said region of interest by electronically dividing said exposed image region into a plurality of areas of equal size, and selecting at least one of said areas as said region of interest.

3. A method as claimed in claim 2 wherein said exposed image region has two perpendicular dimensions, and wherein the step of determining the region of interest comprises dividing said exposed image region into nine areas with three divisions in each of said dimensions.

4. A method as claimed in claim 3 wherein said nine areas include a middle area, and selecting said middle area as said region of interest.

5. A method as claimed in claim 2 comprising selecting a combination composed of plurality of said areas as said region of interest.

6. A method as claimed in claim 5 comprising forming said combination from a plurality of non-contiguous areas.

7. A method as claimed in claim 5 comprising forming said combination from a plurality of contiguous areas.

8. A method as claimed in claim 2 comprising differently weighting the grey scale values of the respective areas.

9. A method as claimed in claim 1 comprising electronically calculating said x-ray image exposure value by forming a mean value of the grey scale values of pixels in said region of interest.

10. A method as claimed in claim 9 comprising electronically discarding a plurality of highest grey scale values in said region of interest and a plurality of lowest grey scale values in said region of interest before electronically calculating said mean value.

11. A method as claimed in claim 1 comprising electronically calculating said x-ray image exposure value by forming a median value of the grey scale values of pixels in said region of interest.

12. A method as claimed in claim 9 comprising electronically discarding a plurality of highest grey scale values in said region of interest and a plurality of lowest grey scale values in said region of interest before electronically calculating said median value.

13. A method as claimed in claim 1 wherein the step of electronically mathematically converting said normalized value to a physical unit comprises employing a mathematical model in the conversion.

14. A method as claimed in claim 13 comprising converting said normalized value to said physical unit by electronically calculating a spectrum of said x-rays striking said radiation detector from a model for a kV value employed to generate said x-rays and an assumed increase in radiation hardness due to filtering of said x-rays and an effect of a patient on said x-rays.

15. A method as claimed in claim 14 comprising calculating a radiation dose as said physical unit.

16. A method as claimed in claim 13 comprising mathematically converting said normalized value to said physical unit comprises obtaining a raster of measurements selected from the group consisting of an actual kV value used to generate said x-rays, a signal strength of the output signal from said radiation detector, and an estimated radiation hardness increase due to filtering of said x-rays and an effect of a patient on the x-rays and interpolating from said raster.

17. A method as claimed in claim 13 wherein said physical unit is a radiation dose, and wherein the step of electronically converting said normalized value into said radiation dose comprises calculating said radiation dose from a linear transformation between said normalized value and said radiation dose.

18. A method as claimed in claim 1 comprising electronically determining said exposed image region directly from the output signal from said radiation detector, with no processing of said output signal from said radiation detector.

19. A method as claimed in claim 1 comprising processing the output signal from the radiation detector, using a processing algorithm, to produce a processed signal, and before electronically determining said exposed image region, electronically operating on said processed signal using an algorithm that is an inverse of said processing algorithm, to restore said output signal of said detector prior to said processing with said processing algorithm.

20. An x-ray diagnostic apparatus comprising:
an x-ray source for emitting x-rays,
a radiation detector on which said x-rays are incident, said radiation detector generating an electrical output signal dependent on the x-rays incident thereon;
an image system supplied with said output signal from said radiation detector for generating an image signal from said output signal;
a display device for displaying an image corresponding to said image signal;
said image system comprising an exposed image region determination unit, supplied with the output signal from said radiation detector, for determining an exposed image region of said radiation detector;
an ROI determination unit, supplied with an output from said exposed image region determination unit, for determining a region of interest in said exposed image region, a first calculation unit supplied with an output from said ROI determination unit for determining an x-ray image exposure value from the grey scale values of the pixels in said region of interest; and
a normalization unit supplied with an output from said first calculation unit for normalizing said x-ray image exposure value with respect to a signal value, for producing a normalized value, a measurement unit for independently determining at least one measurement value associated with generation of said exposed image region, a second calculation unit supplied with said normalized value and said measurement value for mathematically converting said normalized value into a physical unit, using said measurement value, and a storage unit for storing said physical unit in association with said measurement value for documentation.

21. An x-ray diagnostic apparatus as claimed in claim 20 wherein said first calculation unit determines said x-ray image exposure value as a mean value of the grey scale values of the pixels in said region of interest.

22. An x-ray diagnostic apparatus as claimed in claim 20 comprising a filter for filtering said x-rays with a filter value, and wherein said x-ray source employs a kV value for generating said x-rays and has a mAs value associated therewith, and wherein said measurement device measures said kV value, said mAs value and said filter value as a plurality of said measurement values.

23. An x-ray diagnostic apparatus as claimed in claim 20 wherein said second calculation unit converts said normalized value into said physical unit dependent on a mathematical model, using said measurement value.

24. An x-ray diagnostic apparatus as claimed in claim 20 wherein said measurement unit determines calibration data as said at least one measurement value, and wherein said second calculation unit converts said normalized value into said physical unit from a linear transformation between said normalized value and said calibration data.
